(19) United States
(12) Patent Application Publication
(10) Pub. No.: US 2023/0157301 A1
(43) Pub. Date: May 25, 2023

(54) ANTIVIRAL MATERIAL

(71) Applicant: AGC INC., Tokyo (JP)

(72) Inventors: Satoshi KASHIWABARA, Tokyo (JP); Takahiro MASHIMO, Tokyo (JP); Kumiko SUWA, Tokyo (JP); Yoshitake TODA, Tokyo (JP); Nobuhiro NAKAMURA, Tokyo (JP); Takaaki MURAKAMI, Tokyo (JP)

(73) Assignee: AGC INC., Tokyo (JP)

(21) Appl. No.: 18/157,208

(22) Filed: Jan. 20, 2023

Related U.S. Application Data
(63) Continuation of application No. PCT/JP2021/026880, filed on Jul. 16, 2021.

(30) Foreign Application Priority Data
Jul. 22, 2020 (JP) 2020-125649

(51) Int. Cl. A01N 59/20; A01N 59/06; C09D 7/61; C09D 5/14; D01F 1/10

(52) U.S. Cl. CPC A01N 59/20; A01N 59/06; C09D 7/61; C09D 5/14; D01F 1/103

(57) ABSTRACT

The present invention relates to an antiviral material including a Cu-M-O compound, in which the Cu at least includes a monovalent-state Cu and the M is at least one element selected from the group consisting of B, Al, Sc, Ti, Co, Cr, Ni, Ga, Y, Zr, In, Rh, and a lanthanoid.

### CROSS-REFERENCE TO RELATED APPLICATIONS

This is a bypass continuation of International Patent Application No. PCT/JP2021/026880, filed on Jul. 16, 2021, which claims priority to Japanese Patent Application No. 2020-125649, filed on Jul. 22, 2020. The contents of these applications are hereby incorporated by reference in their entireties.

### TECHNICAL FIELD

The present invention relates to an antiviral material.

### BACKGROUND ART

Viruses include ones which infect humans, such as avian influenza viruses, noroviruses, rotaviruses, coronaviruses, and retroviruses, and bacterial viruses (also called bacteriophages or phages) which infect bacteria to cause bacteriolysis.

Antiviral materials capable of exhibiting an antiviral effect are being developed in order to prevent viral infections. It is known that substances including copper (Cu), especially monovalent copper, are effective, but the mechanism thereof is still unclear.

For example, Non-Patent Document 1 indicates that copper that has entered the inside of a virus through diffusion combines with Vpg protein, which is some of RNA polymerase of the virus, to inhibit RNA duplication or inhibits an enzyme which cuts duplicated poly-RNAs to thereby inhibit the duplication of the virus. Non-Patent Document 1 further indicates that active oxygen generated by the copper causes damage to the virus.

Meanwhile, Non-Patent Document 2 indicates that virus-inactivating ability does not decrease even in an oxygen-free state. Under current circumstances, there are many unclear points regarding by what mechanisms the copper or the compound including monovalent copper inactivates viruses.

Patent Document 1, for example, discloses, as an antiviral material containing monovalent copper, an antiviral agent including as an effective ingredient at least one monovalent-copper compound selected from the group consisting of CuCl, CuOOCCH₃, CuBr, CuI, CuSCN, Cu₂S, and Cu₂O. Patent Document 2 discloses a virus inactivator in the form of a composition including one or more monovalent-copper compounds and one or more visible-light-responsive photocatalyst substances.

### CITATION LIST

### Patent Literature

Patent Document 1: JP-A-2014-231525
Patent Document 2: JP-A-2011-153163

### Non-Patent Literature

Non-Patent Document 1: M. Vincent, Journal of Applied Microbiology, Vol. 124, pp. 1032-1046, 2017
Non-Patent Document 2: Sunada Kayano, Kōkin/kōuirusu Zairyō No Kaihatsu/hyōka To Kakō Gijutsu, Technical Information Institute Co., Ltd., 2013, pp. 20-26

### SUMMARY OF INVENTION

### Technical Problems

Requirements which antiviral materials are required to satisfy first include high antiviral properties. The term “high antiviral properties” means to have high ability to inactivate a virus or to retain inactivating ability over a long period. Other requirements include that the antiviral material preferably is a stable substance and is not harmful to organisms including humans and to the environment. In addition, in view of use in various applications, preferably the antiviral material is colorless and transparent or is approximately colorless and transparent.

However, CuCl, CuBr, CuI, and CuSCN, which are mentioned in Patent Document 1, are toxic and exert adverse influences especially on aquatic organisms. Cu₂S and Cu₂O are a black compound and a red compound, respectively, and hence have limited uses. Furthermore, CuOOCCH₃ has a drawback in that this compound has low stability because it decomposes with moisture to yield Cu₂O.

Meanwhile, the virus inactivator described in Patent Document 2 is low in production efficiency because it is necessary to separately produce a monovalent-copper compound and a photocatalyst substance and to mix these together. The virus inactivator described in Patent Document 2 further has a problem in that the incorporation of the photocatalyst results in a decrease in the proportion of the monovalent-copper compound and hence in a decrease in virus-inactivating ability.

An object of the present invention, which has been achieved in view of these problems, is to provide an antiviral material which has high antiviral properties, is stable and harmless to organisms and the environment, and is colorless and transparent or is approximately colorless and transparent.

### Solution to Problems

The present inventors diligently made investigations in order to overcome those problems and, as a result, have discovered that a composite copper oxide including monovalent copper and a specific metallic or semimetallic element has high antiviral properties and is useful as an antiviral material.

The present invention relates to the following <1> to <9>

<1> An antiviral material including a Cu-M-O compound, in which the Cu at least includes a monovalent-state Cu and the M is at least one element selected from the group consisting of B, Al, Sc, Ti, Co, Cr, Ni, Ga, Y, Zr, In, Rh, and a lanthanoid.
<2> The antiviral material according to <1>, in which the Cu-M-O compound includes delafossite crystals represented by CuMO₂.
<3> An antiviral material including a Cu-M-M′-O compound, in which the Cu at least includes a monovalent-state Cu, the M is at least one element selected from the group consisting of B, Al, Sc, Ti, Co, Cr, Ni, Ga, Y, Zr, In, Rh, and a lanthanoid, and the M′ is Ag or Pd.
<4> The antiviral material according to <3>, in which the Cu-M-M′-O compound includes delafossite crystals represented by (Cu-M′)MO₂.
<5> A laminate including a base, and a thin film disposed on the base and including the antiviral material according to any one of <1> to <4>.
<6> Particles including the antiviral material according to any one of <1> to <4>.
<7> A coating material including the particles according to <6>.
<8> A coated object including a base, and a coating film disposed on the base and formed from the coating material according to <7>.
<9> A fiber including the antiviral material according to any one of <1> to <4>.

### Advantageous Effects of Invention

The present invention can provide an antiviral material having high antiviral properties. The antiviral material of the present invention is stable and hence has excellent durability and excellent weatherability. The antiviral material of the present invention is not toxic to humans and other organisms, and imposes no environmental burden. Furthermore, the antiviral material of the present invention is colorless and transparent or is approximately colorless and transparent, and can hence be used in various applications. Consequently, the antiviral material of the present invention is applicable to various products including goggles, face shields, protective garments, panels, coating materials, and coating fluids for touch panels, and can diminish contact viral infections.

### BRIEF DESCRIPTION OF DRAWINGS

FIG. 1 is a graph showing results of calculations of a relationship between the proportion in which the Cu of CuAlO₂ has been replaced by Ag or Pd and energy changes at valence band maximum (VBM), the results being determined by first-principles calculations based on a density functional theory.

FIG. 2 is a graph showing spectral transmittances of Examples 1 and 2.

### DESCRIPTION OF EMBODIMENTS

The present invention is described below but the present invention is not limited by the embodiments or examples shown below.

In this description, “mass” has the same meaning as “weight”.

The antiviral material according to a first embodiment of the present invention includes a Cu-M-O compound, in which the Cu at least includes a monovalent-state Cu and the M is at least one element (hereinafter referred to also as “specific element(s)”) selected from the group consisting of B, Al, Sc, Ti, Co, Cr, Ni, Ga, Y, Zr, In, Rh, and a lanthanoid.

The antiviral material according to a second embodiment of the present invention includes a Cu-M-M′-O compound, in which the Cu at least includes a monovalent-state Cu, the M is the specific element(s), i.e., at least one element selected from the group consisting of B, Al, Sc, Ti, Co, Cr, Ni, Ga, Y, Zr, In, Rh, and a lanthanoid, and the M′ is Ag or Pd.

The present inventors have discovered that the compounds of the first and second embodiments are high in an ionization potential, which is energy difference between vacuum level and valence band maximum (VBM). It is presumed that antiviral materials including these compounds, due to the high ionization potential, have enhanced antiviral properties. The antiviral material of the present invention can inactivate viruses and can retain the effect over a long period.

Although Cu and Cu oxides are known to have catalytic properties, the Cu-M-O compound and the Cu-M-M′-O compound as the antiviral materials of the present invention exhibit the antiviral effect due to not a photocatalytic effect but the antiviral ability of themselves.

### Antiviral Material According to First Embodiment

The antiviral material according to the first embodiment is preferably delafossite crystals represented by CuMO₂ (M is as defined above). Specific examples thereof include CuBO₂, CuAlO₂, CuScO₂, CuTiO₂, CuCoO₂, CuCrO₂, CuNiO₂, CuGaO₂, CuYO₂, CuZrO₂, CuInO₂, and CuRhO₂.

The antiviral material according to the first embodiment has a higher ionization potential than CuI and other Cu compounds disclosed hitherto, and hence has higher antiviral properties. In particular, the delafossite crystals are chemically stable and hence harmless to organisms and the environment.

Furthermore, in the case where the antiviral material includes any of B, Al, Sc, Co, Cr, Ga, Y, In, or a lanthanoid, among the specific elements, this antiviral material shows little absorption in the visible-light region and is approximately colorless and transparent. This antiviral material is hence more reduced in application limitations due to coloration.

### Antiviral Material According to Second Embodiment

The antiviral material according to the second embodiment is one formed by replacing some of the Cu of the Cu-M-O compound of the first embodiment by Ag or Pd. The present inventors have discovered that replacing some of the Cu of the Cu-M-O compound by Ag or Pd provides the effect of further increasing the ionization potential.

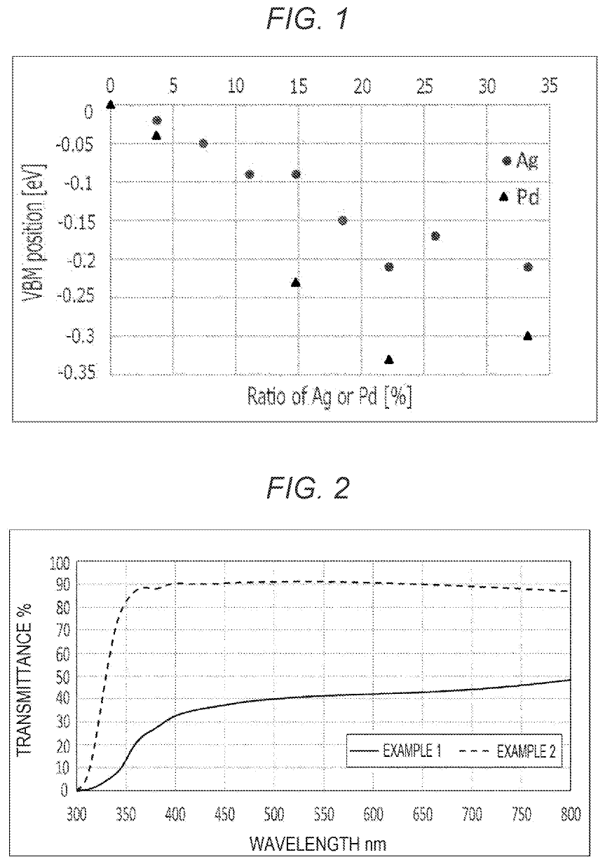

In FIG. 1 are shown results of calculations of a relationship between the proportion in which the Cu of CuAlO₂ has been replaced by Ag or Pd and energy changes at valence band maximum (VBM), the results being determined by first-principles calculations based on a density functional theory. The code used for the calculations was CASTEP. With respect to exchange correlation potentials, the generalized gradient approximation by Perdew-Burke-Ernzerhof was used, and norm-conserving pseudopotentials for the respective elements were used. The plane-wave cutoff energy was set at 925 eV, and a supercell obtained by expanding a unit cell to 3×3×1 was evaluated for VBM change based on the energy at a density of states (DOS) mainly including oxygen 2 s orbit, among DOSs calculated for replacement of Cu by Ag or Pd in any proportions.

It can be seen from FIG. 1 that stable crystal structures are kept up to a degree of replacement of 33 atom %, to which the calculations have been made, regardless of whether Cu was replaced by Ag or Pd. It can also be seen that as the degree of replacement of Cu by either Ag or Pd increases, the VBM decreases in energy level and the ionization potential increases in both cases. Thus, the antiviral properties can be enhanced.

From the standpoint of further heightening the effect of the present invention, the degree of replacement of Cu by Ag or Pd is preferably 3 atom % or more, more preferably 10 atom % or more, still more preferably 20 atom % or more. An upper limit of the degree of replacement of Cu by Ag or Pd is preferably 80 atom % or less, more preferably 60 atom % or less, still more preferably 40 atom % or less, from the standpoints of maintaining an amount of Cu atoms and maintaining the crystal structure.

The antiviral material according to the second embodiment is preferably delafossite crystals represented by (Cu-M′)MO₂ (M and M′ are as defined above). Specific examples thereof include (Cu—Ag)BO₂, (Cu—Pd)BO₂, (Cu—Ag)AlO₂, (Cu—Pd)AlO₂, (Cu—Ag)ScO₂, (Cu—Pd)ScO₂, (Cu—Ag)TiO₂, (Cu—Pd)TiO₂, (Cu—Ag)CoO₂, (Cu—Pd)CoO₂, (Cu—Ag)CrO₂, (Cu—Pd)CrO₂, (Cu—Ag)NiO₂, (Cu—Pd)NiO₂, (Cu—Ag)GaO₂, (Cu—Pd)GaO₂, (Cu—Ag)YO₂, (Cu—Pd)YO₂, (Cu—Ag)ZrO₂, (Cu—Pd)ZrO₂, (Cu—Ag)InO₂, (Cu—Pd)InO₂, (Cu—Ag)RhO₂, and (Cu—Pd)RhO₂.

As stated above, the delafossite crystals are chemically stable and hence harmless to organisms and the environment.

Furthermore, in the case where the antiviral material includes any of B, Al, Sc, Co, Cr, Ga, Y, In, or a lanthanoid, among the specific elements, this antiviral material shows little absorption in the visible-light region and is approximately colorless and transparent. This antiviral material is hence more reduced in application limitations due to coloration.

### <Particles of the Antiviral Material>

The antiviral material of the present invention can be obtained in the form of particles. The particles are obtained, for example, by a common method for producing inorganic-compound particles, such as a solid-phase reaction method, a hydrothermal method, a sol-gel method, a liquid-phase combustion method, or a thermal plasma method. These methods are equal in mixing Cu, M, and O or Cu, M, M′, and O in a stoichiometric ratio and reacting these, but are different in starting materials and in the size of particles to be obtained. In each process, crystals of CuMO₂ or (Cu-M′)MO₂ can be obtained under selected conditions.

Those production methods are explained below with respect to production of the Cu-M-O compound as an example. However, the Cu-M-M′-O compound can also be produced likewise.

### (Solid-Phase Reaction Method)

In the solid-phase reaction method, either powders of oxides of Cu and M to be contained in the desired Cu-M-O compound or powders of composite oxides of Cu and M to be contained in the desired Cu-M-O compound are used as starting materials, and are mixed together so as to result in the stoichiometry in the desired compound. The Cu-containing starting materials are preferably ones containing Cu in a monovalent oxidized state, e.g., Cu₂O.

Methods for mixing the oxide powders are not particularly limited, and a ball mill is generally used. This mixing may be either a dry process or a wet process. However, in the case of using a wet process, it is necessary to select a liquid in which the starting-material oxides do not dissolve.

The powders which have been mixed together in any desired method, e.g., using a ball mill, are put, either as such or after having been formed into tablets, into a crucible made of aluminum oxide, magnesium oxide, zirconium oxide stabilized with yttrium oxide, or the like, and burned for 2 hours or longer. With respect to the kind of crucible, one which does not react with the mixture of the starting material powders at the burning temperature is suitably selected.

The burning temperature is generally about 900-1,200° C., and can be selected at will in accordance with the desired compound.

It is preferred to conduct the burning in an inert-gas atmosphere, e.g., carbon dioxide gas (CO₂), nitrogen gas (N₂), or argon gas (Ar), in which partial oxygen pressure was lowered as much as possible, or in a vacuum, in order to maintain the monovalent oxidized state of the Cu.

By performing the burning at an appropriate temperature, solid-phase reactions are caused to occur between starting-material powder particles and the desired Cu-M-O compound is obtained. Since the solid-phase reaction method is conducted at relatively high temperatures, there are cases where the product particles have grown and sintered. The size of particles to be obtained by this method depends on a re-pulverization step to be conducted after the burning. In the case where the product of the burning is re-pulverized with a common ball mill or homogenizer to yield particles, the obtained particles have sizes of about 1-10 μm.

### (Hydrothermal Method)

In the hydrothermal method, a Cu halide (Cu-h), e.g., CuCl, and a composite oxide (AMOx) of a metal M and an alkali metal, e.g., NaMOx, are used as starting materials.

The Cu-h and the AMOx in the same stoichiometry as in the desired Cu-M-O compound are dissolved in an aqueous solution of a hydroxide of an alkali metal including the same alkali metal as in the composition of the AMOx. The solution is homogenized and then filled into an autoclave, and heated at any desired temperature around 300-400° C. for about 5 hours to thereby obtain a precipitate.

This precipitate is rinsed with a dilute hydrochloric acid solution, a dilute ammonia solution, pure water, and ethanol or the like in this order, and dried to thereby obtain a powder of the desired Cu-M-O compound. Since this method includes no high-temperature burning step, particles with sizes of about 1-2 μm are obtained.

### (Sol-Gel Method)

In the sol-gel method, nitrates of Cu and M to be contained in the desired Cu-M-O compound are used as starting materials.

These nitrates are dissolved in pure water so as to result in the same stoichiometry as in the desired compound. Citric acid is added thereto to produce a metal/citric acid complex. Ethylene glycol is further added thereto, and the mixture is stirred at any desired temperature around 25-200° C. for about 2 hours to thereby obtain a gel-state precursor in which the Cu and the M have been mixed together on an atomic level.

This gel-state precursor is heated in the air at any desired temperature around 300-400° C. for about 2-10 hours to thereby obtain a primary powder.

This primary powder is burned at any desired temperature around 750-1,200° C. in an inert gas atmosphere or in a vacuum as in the solid-phase reaction method to thereby obtain the desired Cu-M-O compound. In the sol-gel method, since the Cu and M in the primary powder to be burned have been mixed with each other on an atomic level, the desired compound can be obtained even when the burning is conducted at lower temperatures than in the solid-phase reaction method. Thus, particles with sizes of 30-70 nm can be produced.

Particle synthesis by the sol-gel method is not limited to ones involving the materials and process shown above.

### (Liquid-Phase Combustion Method)

In the liquid-phase combustion method, nitrate hydrates of Cu and M to be contained in the desires Cu-M-O compound are used as starting materials.

These nitrate hydrates are dissolved in pure water so as to result in the same stoichiometry as in the desired compound. Hexamine or the like, which serves as both an oxidizing agent and a fuel, is added thereto, and the mixture is stirred.

The resultant solution is transferred to, for example, a crucible made of aluminum oxide, magnesium oxide, zirconium oxide stabilized with yttrium oxide, or the like, and then heated and combusted using a hot plate or an electric furnace. The combustion is conducted at 300-600° C. until the liquid phase disappears, and the obtained precursor is burned. Alternatively, the solution in the state of having begun to combust may be transferred to an electric furnace having any desired temperature and burned as such.

In the latter method, a temperature of 1,000° C. or higher is necessary for obtaining the desired Cu-M-O compound and, hence, the obtained particles have sizes of about 1-10 μm like the particles obtained by the solid-phase reaction method. In the former method, in the case where the combustion temperature is properly set, the precursor may have a composition which is a mixture of Cu₂O and MOx, and this precursor, upon burning at about 800° C., becomes the Cu-M-O compound. In the former method, particle growth is inhibited because of the low temperature, and particles of sub-micrometer sizes are obtained.

### (Thermal Plasma Method)

A thermal plasma method is a method in which starting materials are vaporized by a plasma to obtain a desired substance. The size of the substance can be controlled by regulating the concentration of the vaporized starting materials, and the particle diameter can be regulated to from nanometer size to micrometer size and even to larger sizes. A plasma source may be a high-frequency plasma.

Either powders of oxides of Cu and M to be contained in the desired Cu-M-O compound or powders of composite oxides of Cu and M to be contained in the desired Cu-M-O compound are used as starting materials. The starting materials are introduced into a plasma chamber, either as the powder state, or as a dispersion in, for example, ethanol.

The powder vaporizes and aggregates in the plasma chamber, during which the Cu-M-O compound is obtained. The desired compound is obtained by suitably selecting the amounts of the starting materials to be introduced. An inert gas, e.g., Ar, can be introduced to maintain the plasma, and oxygen and hydrogen can be introduced to regulate the composition.

The particles formed by the aggregation are cooled in a cooling zone disposed under the chamber and then recovered with a bag filter or the like.

### (Electrolytic Spinning Method)

An acetate of Cu and a nitrate of each of M and M′ can be applied to an electrolytic spinning method. In the case of using these salts to form an antiviral material, the antiviral material has a fiber shape with a diameter on the order of about sub-micrometer.

In the electrolytic spinning method, the acetate of Cu and the nitrate of M are dissolved in dimethylformamide (DMF) so as to result in the same stoichiometry as in the desired Cu-M-O compound, and the solution is stirred for about 1 hour. Thereafter, polyvinylpyrrolidone is added thereto and the mixture is further stirred for about 12 hours, and then filled into a syringe for electrostatic spinning. The voltage between the syringe and a substrate is adjusted to about 15 kV and electrolytic spinning is conducted. Thereafter, an intermediate product is removed from the substrate.

The intermediate product is dried and then calcined and burned to thereby obtain a fibrous Cu-M-O compound.

The drying temperature is 80-200° C., the calcination temperature is 400-600° C., and the burning temperature is 900-1,200° C. A holding period for each of these treatments may be selected at will from the range of about from 10 minutes to 5 hours.

### <Thin Film of the Antiviral Material>

The antiviral material of the present invention can be obtained as a thin film. The thin film including the antiviral material of the present invention has high antiviral properties.

The thin film is obtained by forming on a base a film including the antiviral material of the present invention. Thus, a laminate including the base and the thin film united therewith is obtained.

Examples of methods for forming the thin film on the base include a dry coating method.

### (Dry Coating Method)

In the dry coating method, a thin film of the antiviral material is formed on a surface of the base using a vacuum.

Examples of the dry coating method include magnetron sputtering, vacuum vapor deposition, ion-beam-assisted vapor deposition, and ion-beam sputtering.

The base is not particularly limited, and examples thereof include glasses and organic resins. Preferred of these include transparent bases made of glasses, organic resins, etc. Examples of the glasses include soda-lime glasses and laminated glasses, which are mainly used as plate glasses and automotive glasses. Examples of the organic resins include resins such as polycarbonates, acrylics, polyethylene, polypropylene, and poly(ethylene terephthalate).

The shape of the base is not limited to flat plates, and the base may entirely or partly have a curvature.

In magnetron sputtering, a thin film made of the antiviral material of the present invention (the Cu-M-O compound or the Cu-M-M′-O compound) is formed by any of the following methods (1) to (4).

(1) Copper and the metal(s) other than copper are successively adhered to or deposited on the base surface with heating.
(2) Copper and the metal(s) other than copper are successively adhered to or deposited on the base surface and then heat-treated.
(3) Copper and the metal(s) other than copper are simultaneously adhered to or deposited on the base surface with heating.
(4) Copper and the metal(s) other than copper are simultaneously adhered to or deposited on the base surface and then heat-treated.

The methods for forming a thin film (antiviral film) including the Cu-M-O compound by magnetron sputtering are explained below. The same explanation applies to the methods for forming a thin film including the Cu-M-M′-O compound.

### Method (1)

A substrate is disposed in a chamber of a magnetron sputtering device equipped with a pure-copper target, and the chamber is evacuated to 5.0×10⁻⁴ Pa or less. Thereafter, the substrate in the chamber is heated to and held at 200-500° C. Since the pressure in the chamber increases due to the heating, the chamber is further evacuated until the pressure in the chamber decreases to 5.0×10⁻⁴ Pa or less.

After the heating and evacuation, argon gas and oxygen gas are introduced, a pulsed DC voltage is applied to the target to generate a plasma, and a copper oxide compound is yielded on the substrate by magnetron sputtering. The voltage to be applied to the target may be a DC voltage, an RF voltage, or an AC (bipolar type AC) voltage. The target material may be a copper-oxide target. In the case of a copper-oxide target that is high in the proportion of Cu₂O, which has high electrical resistance, RF is selected as a power source.

The M, which is a metal other than copper, is chips that have been processed into a thin plate shape, and is evenly disposed on the target. By regulating the number of the chips to be disposed and regulating the positions thereof, a desired composition is obtained. After the film formation, a sample may be taken out and reheated after the film formation in order to regulate the crystallinity of the CuMO₂.

### Method (2)

A substrate is disposed in a chamber of a magnetron sputtering device equipped with a pure-copper target, and the chamber is evacuated to 5.0×10⁴ Pa or less. Thereafter, argon gas and oxygen gas are introduced. A pulsed DC voltage is applied to the pure-copper target to generate a plasma, and a copper oxide compound is yielded on the substrate by magnetron sputtering. The voltage to be applied to the target may be a DC voltage, an RF voltage, or an AC (bipolar type AC) voltage. The target material may be a copper-oxide target. In the case of a copper-oxide target that is high in the proportion of Cu₂O, which has high electrical resistance, RF is selected as a power source.

The M, which is a metal other than copper, is chips that have been processed into a thin plate shape, and is evenly disposed on the target. By regulating the number of the chips of M to be disposed and regulating the positions thereof, a desired composition is obtained. Besides being disposed as chips, the M may be used as a Cu-M alloy material target. Alternatively, a Cu target and an M target may be produced separately and disposed by evenly bonding these to a backing plate.

After the film formation, the substrate is taken out of the chamber and heated in the air at 200-500° C. for 5-120 minutes. It is also possible to take out a sample and conduct reheating after the film formation under conditions different from those for the first heating, in order to regulate the crystallinity of the CuMO₂.

### Method (3)

A substrate is disposed in a chamber of a magnetron sputtering device in which a copper target and a target made of the M, which is a metal other than copper, have been disposed. The chamber is evacuated to 5.0×10⁻⁴ Pa or less. Thereafter, the substrate is heated to and held at 200-500° C.

Since the pressure in the chamber increases through the heating, the chamber is continuously evacuated until the pressure in the chamber decreases to 5.0×10⁻⁴ Pa or less.

After the heating and evacuation, argon gas and oxygen gas are introduced, a pulsed DC voltage is applied to the targets to generate a plasma, and a copper oxide compound is yielded on the substrate by magnetron sputtering. The electric power to be applied to the targets is regulated so as to result in a desired composition. The voltage to be applied to the targets may be a DC voltage, an RF voltage, or an AC (bipolar type AC) voltage. The target material may be a copper-oxide target.

Thereafter, argon gas and oxygen gas are introduced, and a pulsed DC voltage is applied to the targets to generate a plasma. The voltage to be applied here may be a DC voltage, an RF voltage, or an AC (bipolar type AC) voltage. The target materials may be an oxide of copper and an oxide of the M. In the case where the target materials have high electrical resistance, RF is selected as a power source. Furthermore, it is possible to take out a sample and conduct reheating after the film formation in order to regulate the crystallinity of the CuMO₂.

### Method (4)

A substrate is disposed in a chamber of a magnetron sputtering device in which a copper target and a target made of the M, which is a metal other than copper, have been disposed. The chamber is evacuated to 5.0×10⁻⁴ Pa or less. Thereafter, argon gas and oxygen gas are introduced. A pulsed DC voltage is applied to the targets to generate a plasma, and a copper oxide compound is yielded on the substrate by magnetron sputtering. The electric power to be applied to the targets is regulated so as to result in a desired composition. The voltage to be applied here may be a DC voltage, an RF voltage, or an AC (bipolar type AC) voltage. The target materials may be an oxide of copper and an oxide of the M. In the case where the target materials have high electrical resistance, RF is selected as a power source.

After the film formation, the substrate is taken out of the chamber and heated in the air at 200-500° C. for 5-120 minutes. It is also possible to take out a sample and conduct reheating after the film formation under conditions different from those for the first heating, in order to regulate the crystallinity of the CuMO₂.

In the case where the thin film is too thick, there are drawbacks in that the film may crack or cause interference fringes and that flaws which have occurred in the film are noticeable. In the case where the thin film is too thin, there is a possibility that the desired antiviral properties might not be exhibited. The thickness of the thin film is preferably 10-5,000 nm, particularly preferably 100-3,000 nm, when profitability is also taken into account.

### <Coating Film of the Antiviral Material>

The antiviral material of the present invention can each be obtained also as a film-coated base by applying a coating material containing particles including the antiviral material of the present invention to a surface of a base to form a coating film on the base. The coating film including the antiviral material of the present invention has high antiviral properties.

The coating film is obtained by forming on a base a film including the antiviral compound of the present invention. Thus, a coated object including the base and the coating film united therewith is obtained.

Examples of methods for forming the coating film on the base include a wet coating method.

### (Wet Coating Method)

In the wet coating method, a coating material containing particles including the antiviral material is applied to a surface of the base to obtain a film-coated base including the base and a coating film formed thereon.

Examples of the wet coating method include coating techniques such as spin coating, wipe coating, spray coating, squeeze coating, casting, die coating, ink-jet coating, flow coating, roll coating, dip coating, gravure coating, coating with a brush, coating by hand, and curtain flow coating.

The coating material for forming the coating film of the present invention includes: particles of the antiviral material of the present invention (hereinafter referred to as antiviral-material particles), which include the Cu-M-O compound or the Cu-M-M′-O compound; a binder; and a liquid medium. A dispersant for dispersing the antiviral-material particles may be incorporated into the coating material according to need.

The coating film is formed by applying the coating material to a surface of the base to form a wet film and then removing the liquid medium, and includes the antiviral-material particles and the binder.

With respect to the average particle diameter of the antiviral-material particles for use in forming the coating film, the particles having any of various sizes can be used in accordance with purposes. In the case of use in transparent applications, the average particle diameter of the antiviral-material particles is preferably 5-100 nm from the standpoint of ensuring transparency, and is more preferably 40-70 nm. In the case where the average particle diameter thereof is too small, the antiviral-material particles are buried in the formed film, making the antiviral effect less apt to be exhibited. Meanwhile, in the case where the average particle diameter thereof is too large, there is a possibility that the formed coating film might have insufficient mechanical strength and transparency cannot be ensured.

The average particle diameter can be determined by a particle size distribution analyzer (e.g., “Microtrac UPA Particle Size Distribution Analyzer”, manufactured by HONEYWELL Inc.) to measure the diameters of aggregates of the fine particles in the coating material using light scattering.

The content of the antiviral-material particles in the coating material is preferably 0.01-20 mass %, more preferably 0.3-10 mass %, based on 100 mass % of the coating material. In the case where the content of the antiviral-material particles in the coating material is 0.01 mass % or more, the coating film sufficiently exhibits the antiviral properties and can retain the effect over a long period. In the case where the content thereof is 20 mass % or less, the dispersed state of the antiviral-material particles can be satisfactorily maintained and a coating film retaining transparency can be formed on a base surface.

The binder is used in order to support the antiviral-material particles of the present invention. The binder, during film formation, has the function of bonding the wet film to the base and, in the coating film, has the function of dispersing and bonding the other component(s).

Examples of the binder include precursors of metal oxides and fluororesins, and appropriate ones can be suitably selected in accordance with a printing or application method, etc. Examples of the precursors of metal oxides include precursors of oxides of metals such as Si, Al, Ti, Ta, Zr, and Sn. It is preferred to use inorganic binders such as a precursor of a metal oxide of Si among those, because such inorganic binders have excellent durability.

The content of the binder in the coating material is preferably 0.0025-30 mass %, more preferably 0.01-10 mass %, based on 100 mass % of the coating material. In the case where the content of the binder is 0.0025 mass % or more, tight adhesion to the base is obtained. In the case where the content thereof is 0.01 mass % or more, the strength of adhesion to the base can be enhanced. Meanwhile, in the case where the content of the binder is 30 mass % or less, the surface of some of the antiviral-material particles can be exposed on the surface of the coating film to make the antiviral-material particles capable of coming into contact with viruses. Thus, a coating film in the state of capable of exhibiting the antiviral effect can be suitably formed on the base surface.

Examples of the liquid medium include water and water-soluble organic solvents. Examples of the water-soluble organic solvents include hydrocarbon organic solvents, e.g., alcohol organic solvents, ketone organic solvents, ether organic solvents, and ester organic solvents.

The content of the liquid medium in the coating material is preferably 50-99.98 mass %, more preferably 80-99.9 mass %, based on 100 mass % of the coating material. In the case where the content of the liquid medium is 50 mass % or more, a hydrolytic condensation reaction can be prevented from proceeding rapidly. In the case where the content thereof is 99.98 mass % or less, the hydrolytic condensation reaction can be caused to proceed sufficiently during coating film formation.

The dispersant may be used in order to evenly disperse the antiviral-material particles in the coating material. Examples of the dispersant include fatty acid amides, ester salts of acidic polyamides, acrylic resins, oxidized polyolefins, and polymers having an affinity for inorganic pigments. Commercial dispersants may be used, and examples thereof include “Disparon” Series (trade name of Kusumoto Chemical Ltd.) and “DISPERBYK” Series (trade name of BYK-Chemie GmbH).

The content of the dispersant in the coating material is preferably 0.001-10 mass %, more preferably 0.003-6 mass %, based on 100 mass % of the coating material. In the case where the content of the dispersant is 0.01 mass % or more, the dispersant can exhibit the effect of dispersing the antiviral-material particles, making it possible to form a coating film retaining transparency. In the case where the content thereof is 10 mass % or less, the dispersing effect can be maintained and a coating film retaining antiviral properties and having high mechanical strength can be formed.

The base to used can be any of the bases mentioned hereinabove, and preferred bases are also the same.

A method for forming a coating film (antiviral film) using particles of the Cu-M-O compound as the antiviral-material particles and using a precursor of a metal oxide of Si as the binder is explained below. The same explanation apples to the case where particles of the Cu-M-M′-O compound are used.

First, the coating material is applied to a surface of a base by wet coating to form a wet film. The area to be coated may be on one surface of the base or on both surfaces thereof.

As the precursor of the metal oxide of Si to be contained in the coating material, use can be made of silicic acid, a partial condensate of silicic acid, an alkali metal silicate, a silane compound having a silicon-atom-bonded hydrolyzable group, or a product of partial hydrolytic condensation of the silane compound.

Specifically, use may be made of either silicic acid produced by desalting a water glass or a sol-gel silica precursor. In the case of the silicic acid produced by desalting, the binder has a large amount of hydrophilic groups and can hence enhance the antiviral effect. In the case of the sol-gel silica precursor, the binder does not have the function of oxidizing monovalent copper ions and hence is expected to maintain the antiviral effect over a long period and is suitable for supporting the particles. In the case where a binder having oxidizing action is used, the monovalent copper is oxidized, making it impossible to maintain the antiviral effect over a long period.

After the coating material including the particles of the Cu-M-O compound, the precursor of the metal oxide of Si, and a water-soluble organic solvent as the liquid medium is applied to a surface of the base to form a wet film, the solvent of the wet film is removed and the precursor of the metal oxide of Si is condensed, thereby forming a layer of the metal oxide of Si.

Examples of conditions for removing the solvent from the wet film and condensing the precursor of the metal oxide of Si include heating the wet film at a temperature in the range of 50-300° C. for 5-30 minutes. Thus, dehydrating condensation occurs between silanol groups of the precursor of the metal oxide of Si and between OH groups of surfaces of the antiviral-material particles and silanol groups of the precursor, and the precursor of the metal oxide of Si is thereby condensed to form a tenaciously bonded layer of the metal oxide of Si. A layer of the metal oxide of Si formed through condensation may have unreacted silanol groups.

It is preferred to give a post-treatment to the coating material which has been applied, for the purposes of removing the medium and heightening the hardness of the film. Examples of the post-treatment include room-temperature drying, heating, irradiation with electromagnetic waves, e.g., ultraviolet light or electron beams, and heating. The heating is preferably conducted at a temperature in the range of 50-700° C., especially 100-350° C., for 5-60 minutes in view of the heat resistance of the base. Especially in the case where the base is a material having low heat resistance, such as an organic resin, or in the case where low-molecular-weight compounds in the base thermally diffuse from the base, it is preferred to conduct irradiation with electromagnetic waves, e.g., ultraviolet light or electron beams, as the post-treatment.

The content of the antiviral-material particles in the coating film may be any such amount that the antiviral-material particles are contained in the layer of the metal oxide of Si and the desired antiviral properties are obtained. Specifically, in the case where the content of the antiviral-material particles is 40-80 mass % based on the whole mass of the coating film, some of the surface of the antiviral-material particles can be exposed in the surface of the coating film to enable the antiviral-material particles to come into contact with viruses. Such contents are hence preferred. In the case where the content of the antiviral-material particles is more than 80 mass %, there is a possibility that the coating film might have poor mechanical strength and the antiviral properties might not last. In the case where the content thereof is less than 40 mass %, there is a possibility that the antiviral-material particles might be buried in the formed coating film and cannot hence exhibit the antiviral effect.

In the present invention, the coating film is preferably one in which one or more metal atoms selected from the group consisting of Cu, Si, and the M lie in the surface of the film. In the case where the formed coating film is in such a state that the metal atoms are exposed in the surface of some of the film, the coating film can come into contact with viruses at higher efficiency to exhibit excellent antiviral properties. It is preferable that the metal atoms be contained in a range of 1-50 nm in thickness from the surface of the coating film. The inclusion of the metal atoms in that range enables the antiviral-material particles to efficiently come into contact with viruses on the base surface to exhibit the antiviral effect.

The coating film of the present invention preferably has an average surface roughness, Ra value, of 1-50 nm. In the case where the Ra value thereof is 1-50 nm, the surface of the coating film can efficiently come into contact with viruses to exhibit higher antiviral properties.

In the present invention, the thickness of the coating film to be obtained can be controlled by regulating the concentration of the coating material, kind of the solvent, application conditions, post-treatment conditions, etc. The coating film of the present invention can be produced so as to have any of various thicknesses in accordance with purposes. In the case where the thickness of the coating film is too large, there are drawbacks in that the film may crack or cause interference fringes and that flaws which have occurred in the film are noticeable. In the case where the thickness thereof is too small, there is a possibility that the desired antiviral properties might not be exhibited. The thickness of the coating film is preferably 10 nm to 5 μm, particularly preferably 10 nm to 2 μm, when profitability is also taken into account.

Another film may be disposed between the base and the coating film. Examples of such film include an ion diffusion barrier layer (in the case where the base is glass, a layer for preventing metal ions from diffusing into the glass). By disposing the ion diffusion barrier layer, the diffusion of metal ions into the glass can be inhibited and the antiviral effect can be maintained over a long period.

The fluororesins usable as the binder are explained below.

The fluororesins applicable to the coating material for applying the antiviral material of the present invention are resins including either a fluoropolymer containing units (hereinafter referred to also as units F) based on a fluoroolefin or a polymer obtained by curing the fluoropolymer. The fluoroolefin is an olefin in which one or more hydrogen atoms each have been replaced by a fluorine atom. In the fluoroolefin, one or more of the hydrogen atoms remaining unreplaced by fluorine atoms may each have been replaced by a chlorine atom.

Examples of the fluoroolefin include a monomer represented by CF₂═CF₂, CF₂═CFCl, CF₂═CHF, CH₂═CF₂, CF₂═CFCF₃, CF₂═CHCF₃, CF₃CH═CHF, CF₃CF═CH₂, or CH₂═CX^{f1}(CF₂)ₙ₁Y^{f1} (where X^{f1} and Y^{f1} are each independently a hydrogen atom or a fluorine atom, and n1 is an integer of 2-10). Preferred fluoroolefins are CF₂═CF₂, CH₂═CF₂, CF₂═CFCl, CF₃CH═CHF, and CF₃CF═CH₂ from the standpoint that these fluoroolefins enable the coated object to have excellent weatherability. Especially preferred is CF₂═CFCl. Two or more fluoroolefins may be used in combination.

The fluoropolymer may be one (fluoropolymer (1)) including units F alone, or may be one (fluoropolymer (2)) including units F and units based on a fluorine-atom-containing monomer which is not a fluoroolefin, or may be one (fluoropolymer (3)) including units F and units based on a monomer containing no fluorine atom.

Examples of the fluoropolymer (fluoropolymer (1)) including units F alone include fluoroolefin homopolymers and copolymers of two or more fluoroolefins. Specific examples thereof include polytetrafluoroethylene, poly(chlorotrifluoroethylene), tetrafluoroethylene/hexafluoropropylene copolymers, and poly(vinylidene fluoride).

Examples of the fluoropolymer (fluoropolymer (2)) including units F and units based on a fluorine-atom-containing monomer which is not a fluoroolefin include fluoroolefin/perfluoro(alkyl vinyl ether) copolymers. Specific examples thereof include tetrafluoroethylene/perfluoro(alkyl vinyl ether) copolymers.

The content of the units F in the fluoropolymer, based on all the units included in the fluoropolymer, is preferably 20-100 mol %, more preferably 30-80 mol %, particularly preferably 40-60 mol %, from the standpoint of the weatherability of the coated object.

From the standpoint of easily regulating the transmittance and reflectance of this coating film for light having each of various wavelengths, the fluoropolymer preferably includes both units (units F) based on a fluoroolefin and units based on a monomer containing no fluorine atom. Examples of the units based on a monomer containing no fluorine atom include units having a crosslinking group and units having no crosslinking group.

Examples of the fluoropolymer (fluoropolymer (3)) including units F and units based on a monomer containing no fluorine atom include chlorotrifluoroethylene/vinyl ether copolymers, chlorotrifluoroethylene/vinyl ether/vinyl ester copolymers, chlorotrifluoroethylene/vinyl ester/allyl ether copolymers, tetrafluoroethylene/vinyl ester copolymers, tetrafluoroethylene/vinyl ester/allyl ether copolymers, and ethylene/tetrafluoroethylene copolymers. Chlorotrifluoroethylene/vinyl ether copolymers are preferred from the standpoint of regulating the transmittance and refractive index of the coating film.

From the standpoint of durability, the fluoropolymer (3) is preferably one containing units having a crosslinking group (hereinafter referred to also as units (1)) as the units based on a monomer containing no fluorine atom. Units (1) may be units based on a monomer having a crosslinking group (hereinafter referred to also as monomer (1)) or may be units obtained by converting crosslinking groups of a fluoropolymer containing units (1) into different crosslinking groups. Examples of such units include units obtained from a fluoropolymer containing units having a hydroxy group by reacting a polycarboxylic acid, an acid anhydride thereof, etc. with the fluoropolymer to convert some or all of the hydroxy groups into carboxy groups.

Examples of the crosslinking group include a hydroxy group, a carboxy group, an amino group, an epoxy group, and a hydrolyzable silyl group. A hydroxy group and a carboxy group are preferred from the standpoint that these groups are effective in further improving the strength of the film.

In the film, the crosslinking groups of units (1) may have been crosslinked with a hardener, which will be described later, or may remain uncrosslinked. The fluoropolymer in the film has preferably been crosslinked by reaction with the hardener. In the case where the crosslinking groups of units (1) have been crosslinked with the hardener, the film has better durability. In the case where the crosslinking groups of units (1) remain uncrosslinked, an inorganic pigment in the film has better dispersibility.

Examples of the monomer (1) having a carboxy group include unsaturated carboxylic acids, (meth)acrylic acid, and monomers obtained by reacting a carboxylic acid anhydride with the hydroxy group of the following monomer having a hydroxy group. Preferred as the monomer (1) having a carboxy group is a monomer represented by X¹¹—Y¹¹ (hereinafter referred to also as monomer (11)). The symbols in the formula have the following meanings. X¹¹ is CH₂═CH—, CH(CH₃)═CH—, or CH₂═C(CH₃)—, and is preferably CH₂═CH— or CH(CH₃)═CH—. Y¹¹ is a carboxy group or a monovalent saturated hydrocarbon group having 1-12 carbon atoms and having a carboxy group, and is preferably a carboxy group or a carboxyalkyl group having 1-10 carbon atoms.

Examples of the monomer (1) having a hydroxy group include the following compounds each having a hydroxy group: vinyl ethers, vinyl esters, ally ethers, allyl esters, (meth)acrylic esters, and ally alcohol. Preferred as the monomer (1) having a hydroxy group is a monomer represented by X¹²—Y¹² (hereinafter referred to also as monomer (12)) or ally alcohol. X¹² is CH₂═CHO—, CH₂═CHCH₂O—, CH₂═CHCOO—, or CH₂═C(CH₃)COO—. Y¹² is a monovalent saturated hydrocarbon group having 2-12 carbon atoms and having a hydroxy group. The monovalent saturated hydrocarbon group may be linear or branched. The monovalent saturated hydrocarbon group may consist of a ring structure or may include a ring structure. The monovalent saturated hydrocarbon group is preferably an alkyl group having 2-6 carbon atoms or an alkyl group including a cycloalkylene group having 6-8 carbon atoms.

Specific examples of the monomer (11) include CH₂═CHCOOH, CH(CH₃)═CHCOOH, CH₂═C(CH₃)COOH, and compounds represented by CH₂═CH(CH₂)ₙ₂COOH (where n2 represents an integer of 1-10).

Specific examples of the monomer (12) include CH₂═CHO—CH₂-cycloC₆H₁₀—CH₂OH, CH₂═CHCH₂O—CH₂-cycloC₆H₁₀—CH₂OH, CH₂═CHOCH₂CH₂OH, CH₂═CHCH₂OCH₂CH₂OH, CH₂═CHOCH₂CH₂CH₂CH₂OH, CH₂═CHCH₂OCH₂CH₂CH₂CH₂OH, CH₂═CHCOOCH₂CH₂OH, and CH₂═C(CH₃)COOCH₂CH₂OH. “-cycloC₆H₁₀—” represents a cyclohexylene group, and the bonding sites of the “-cycloC₆H₁₀—” are usually 1,4-.

Two or more kinds of monomers (1) may be used in combination. The monomers (1) may have two or more kinds of crosslinking groups.

The content of the units (1), based on all the units included in the fluoropolymer (3), is preferably 0.5-35 mol %, more preferably 3-25 mol %, still more preferably 5-25 mol %, particularly preferably 5-20 mol %.

The fluoropolymer (3) preferably has a crosslinked structure from the standpoint that this fluoropolymer (3) is effective in improving the strength of the coating film. Specifically, in the case where the fluoropolymer (3) includes the units (1), this fluoropolymer (3) preferably has a crosslinked structure formed by crosslinking some of the crosslinking groups of the units (1) with, for example, the hardener which will be described later.

That is, the fluoropolymer (3) in this description may be either in a state that some of the crosslinking groups remain or in a state that the crosslinking groups have been crosslinked with a hardener, etc.

The fluoropolymer (3) preferably further contains units (hereinafter referred to also as units (2)) based on a monomer having no crosslinking group (hereinafter referred to also as monomer (2)), as units based on a monomer containing no fluorine atom. The units based on a monomer having no crosslinking group are preferably units based on one or more monomers selected from the group consisting of vinyl ethers, vinyl esters, allyl ethers, allyl esters, and (meth)acrylic esters.

The units (2) are preferably units based on a monomer represented by X²—Y².

X² is CH₂═CHC(O)O—, CH₂═C(CH₃)C(O)O—, CH₂═CHOC(O)—, CH₂═CHCH₂OC(O)—, CH₂═CHO—, or CH₂═CHCH₂O—. Preferred is CH₂═CHOC(O)—, CH₂═CHCH₂OC(O)—, CH₂═CHO—, or CH₂═CHCH₂O—, from the standpoint of imparting excellent weatherability to the antiviral material.

Y² is a monovalent hydrocarbon group having 1-24 carbon atoms. The monovalent hydrocarbon group may be linear or branched. The monovalent hydrocarbon group may consist of a ring structure or may include a ring structure. The monovalent hydrocarbon group may be a monovalent saturated hydrocarbon group or a monovalent unsaturated hydrocarbon group.

The monovalent hydrocarbon group is preferably an alkyl group, a cycloalkyl group, an aryl group, or an aralkyl group, and is particularly preferably an alkyl group having 2-12 carbon atoms, a cycloalkyl group having 6-10 carbon atoms, an aryl group having 6-10 carbon atoms, or an aralkyl group having 7-12 carbon atoms. Specific examples of the alkyl group include a methyl group, an ethyl group, a tert-butyl group, a hexyl group, a nonyl group, a decyl group, and a dodecyl group. Specific examples of the cycloalkyl group include cyclohexyl. Specific examples of the aralkyl group include a benzyl group. Specific examples of the aryl group include a phenyl group and a naphthyl group.

A hydrogen atom of the cycloalkyl group, aryl group, or aralkyl group may have been replaced by an alkyl group. In this case, the number of carbon atoms of the substituent alkyl group is not included in the number of carbon atoms of the cycloalkyl group, aryl group, or aralkyl group.

Two or more kinds of monomers (2) may be used in combination.

Specific examples of the monomer (2) include ethyl vinyl ether, tert-butyl vinyl ether, 2-ethylhexyl vinyl ether, cyclohexyl vinyl ether, vinyl acetate, vinyl pivalate, vinyl neononanoate (trade name “Veova 9”, manufactured by HEXION Inc.), vinyl neodecanoate (trade name “Veova 10”, manufactured by HEXION Inc.), vinyl benzoate, vinyl tert-butylbenzoate, tert-butyl (meth)acrylate, and benzyl (meth)acrylate.

The content of the units (2) is preferably 5-60 mol %, particularly preferably 10-50 mol %, based on all the units included in the fluoropolymer (3).

Commercial products may be used as the fluoropolymer (3), and specific examples thereof include “Lumiflon” Series (trade name of AGC Inc.), “Kynar” Series (trade mane of Arkema Inc.), “Zeffle” Series (trade name of Daikin Industries, Ltd.), “Eterflon” Series (trade name of Eternal Materials Co., Ltd.), and “Zendura” Series (trade name of Honeywell Inc.).

The content of the fluoropolymer in the coating film is preferably 5-95 mass %, particularly preferably 10-90 mass %, based on the whole mass of the coating film from the standpoint of weatherability.

From the standpoint of the adhesion of the coating film to the base, the content of fluorine atoms in the coating film is preferably 65 mass % or less, more preferably 50 mass % or less, still more preferably 40 mass % or less, particularly preferably 25 mass % or less, most preferably 20% or less.

The coating film may have a crosslinked structure configured from the fluoropolymer including both units F and units (1) and a compound (hereinafter referred to also as a hardener) having, in one molecule, two or more groups of at least one kind selected from the group consisting of an isocyanate group, a blocked isocyanate group, an epoxy group, a carbodiimide group, an oxazoline group, a β-hydroxyalkylamide group, a hydrolyzable silyl group, and a silanol group.

In this case, the coating film includes a cured polymer formed from the fluoropolymer. In the case where the coating film includes the crosslinked structure, specifically when crosslinking groups of the units (1) included in the fluoropolymer have been crosslinked with the hardener, then this coating film is excellent in terms of hardness and durability.

The coating film may have a crosslinked structure formed by reaction between two or more selected from among the crosslinking groups of the fluoropolymer included in the coating film, the hardener included in the film, and the base (for example, reactive groups, e.g., silanol groups, present on a surface of a glass plate).

For example, in the case where a film containing a hardener having one or more groups selected from among a hydrolyzable silyl group and a silanol group is to be formed on a glass plate containing silicon oxide, hydrolyzable silyl groups or the like (specifically, silanol groups formed by hydrolysis) of the hardener react with silanol groups present on the surface of the glass plate, thereby forming a crosslinked structure. Because of this, this coating film has better adhesion to the glass plate.

Meanwhile, in the case where a coating film including a fluoropolymer having hydrolyzable silyl groups as crosslinking groups is to be formed on a glass plate containing silicon oxide, then hydrolyzable silyl groups (specifically, silanol groups formed by hydrolysis) of the fluoropolymer react with silanol groups present on the surface of the glass plate, thereby forming a crosslinked structure.

Because of this, this coating film has better adhesion to the glass plate, higher hardness, and higher durability.

A preferred hardener for use in the case where the fluoropolymer has hydroxy groups is a compound having two or more isocyanate or blocked isocyanate groups in one molecule. A preferred hardener for use in the case where the fluoropolymer has carboxy groups is a compound having two or more epoxy groups, carbodiimide groups, oxazoline groups, or β-hydroxyalkylamide groups in one molecule. In the case where the fluoropolymer has both hydroxy groups and carboxy groups, it is preferred to use a compound having two or more isocyanate or blocked isocyanate groups in one molecule in combination with a compound having two or more epoxy groups, carbodiimide groups, oxazoline groups, or β-hydroxyalkylamide groups in one molecule.

From the standpoint of enabling the coating film of the present invention to have further improved adhesion to the glass plate, the coating film preferably contains a hardener having one or more groups selected from among a hydrolyzable silyl group and a silanol group. The compound having two or more isocyanate groups in one molecule is preferably a polyisocyanate monomer or a polyisocyanate derivative.

The polyisocyanate monomer is preferably an alicyclic polyisocyanate, an aliphatic polyisocyanate, or an aromatic polyisocyanate.

The polyisocyanate derivative is preferably a multimer of the polyisocyanate monomer or a modification thereof (biuret form, isocyanurate form, or adduct form).

Specific examples of the aliphatic polyisocyanate include: aliphatic diisocyanates such as tetramethylene diisocyanate, pentamethylene diisocyanate, hexamethylene diisocyanate, 2,2,4-trimethyl-1,6-diisocyanatohexane, and lysine diisocyanate; and lysine triisocyanate, 4-isocyanatomethyl-1,8-octamethylene diisocyanate, and bis(2-isocyanatoethyl) 2-isocyanatoglutarate.

Specific examples of the alicyclic polyisocyanate include alicyclic diisocyanates such as isophorone diisocyanate, 1,3-bis(isocyanatomethyl)cyclohexane, 4,4′-dicyclohexylmethane diisocyanate, norbornene diisocyanate, and hydrogenated xylylene diisocyanate.

Specific examples of the aromatic polyisocyanate include aromatic diisocyanates such as 2,4-tolylene diisocyanate, 2,6-tolylene diisocyanate, 4,4′-diphenylmethane diisocyanate, naphthalene diisocyanate, and xylylene diisocyanate. The compound having two or more blocked isocyanate groups in one molecule is preferably a compound that is the polyisocyanate monomer or polyisocyanate derivative in which the two or more isocyanate groups have been blocked with a blocking agent.

The blocking agent is a compound having active hydrogen, and specific examples thereof include alcohols, phenol, active methylene, amines, imines, acid amides, lactams, oximes, pyrazole, imidazole, imidazoline, pyrimidine, and guanidine.

Specific examples of the compound having two or more epoxy groups in one molecule include bisphenol epoxy compounds (A, F, and S types, etc.), diphenyl ether epoxy compounds, hydroquinone epoxy compounds, naphthalene epoxy compounds, biphenyl epoxy compounds, fluorene epoxy compounds, hydrogenated bisphenol A epoxy compounds, polyol epoxy compounds, polypropylene glycol epoxy compounds, glycidyl ester epoxy compounds, glycidylamine epoxy compounds, glyoxal epoxy compounds, alicyclic epoxy compounds, alicyclic polyfunctional epoxy compounds, and heterocyclic epoxy compounds (e.g., triglycidyl isocyanurate).

Specific examples of the compound having two or more carbodiimide groups in one molecule include alicyclic carbodiimides, aliphatic carbodiimides, aromatic carbodiimides, and multimers and modifications of these.

Specific examples of the compound having two or more oxazoline groups in one molecule include addition-polymerizable oxazoline compounds having 2-oxazoline groups and polymers of the addition-polymerizable oxazoline compounds.

Specific examples of the compound having two or more β-hydroxyalkylamide groups in one molecule include N,N,N′,N′-tetrakis(2-hydroxyethyl)adipamide (Primid XL-552, manufactured by EMS) and N,N,N′,N′-tetrakis(2-hydroxypropyl)adipamide (Primid QM 1260, manufactured by EMS).

Examples of the hardener having one or more groups selected from among a hydrolyzable silyl group and a silanol group include at least one compound selected from among compounds represented by SiZₐR₄₋ₐ and products of partial hydrolytic condensation thereof.

In the formula, R represents a monovalent hydrocarbon group having 1-10 carbon atoms, Z represents an alkoxy group having 1-10 carbon atoms or a hydroxy group, and a represents an integer of 1-4.

R is a monovalent hydrocarbon group having 1-10 carbon atoms. The monovalent hydrocarbon group may have a substituent (e.g., fluorine atom). That is, some or all of the hydrogen atoms of the monovalent hydrocarbon group may have been replaced by the substituent. R is preferably a methyl group, a hexyl group, a decyl group, a phenyl group, or a trifluoropropyl group, etc. In the case where there is a plurality of R moieties in one molecule, the R moieties may be the same or different each other but are preferably the same with each other.

Z is an alkoxy group having 1-10 carbon atoms or a hydroxy group, and is preferably the alkoxy group. In the case where Z is the alkoxy group, the alkoxy group is preferably a methoxy group or an ethoxy group. In the case where there is a plurality of Z moieties in one molecule, the Z moieties may be the same or different each other but are preferably the same with each other.

Symbol a is an integer of 1-4, preferably 2-4.

Specific examples of the compounds represented by SiZₐR₄₋ₐ include tetrafunctional alkoxysilanes (e.g., tetramethoxysilane, tetraethoxysilane, and tetraisopropoxysilane), trifunctional alkoxysilanes (e.g., methyltrimethoxysilane, methyltriethoxysilane, phenyltrimethoxysilane, phenyltriethoxysilane, hexyltrimethoxysilane, hexyltriethoxysilane, decyltrimethoxysilane, and trifluoropropyltrimethyoxysilane), and bifunctional alkoxysilanes (e.g., dimethyldimethoxysilane, diphenyldimethoxysilane, dimethyldiethoxysilane, and diphenyldiethoxysilane). Preferred are tetramethoxysilane, tetraethoxysilane, methyltrimethoxysilane, methyltriethoxysilane, and phenyltrimethoxysilane.

The coating material may contain a non-fluorinated resin. Specific examples of the non-fluorinated resin include an alkyd resin, an aminoalkyd resin, a polyester resin, an epoxy resin, an urethane resin, an epoxy-polyester resin, a vinyl acetate resin, an acrylic resins, a vinyl chloride resin, a phenolic resin, a modified polyester resin, an acryl-silicone resin, and a silicone resin. In the case where the non-fluorinated resin among these examples is a curable resin, the non-fluorinated resin contained in the film is usually a cured resin.

The coating film is preferably formed from a coating material including a fluoropolymer. The coating material is preferably a liquid coating material.

In the case where the fluoropolymer in the coating material is a fluoropolymer containing carboxy groups, this fluoropolymer in the coating material has an acid value of preferably 1-200 mg-KOH/g, more preferably 1-150 mg-KOH/g, still more preferably 3-100 mg-KOH/g, particularly preferably 5-50 mg-KOH/g, from the standpoint of the strength of the coating film.

In the case where the fluoropolymer in the coating material is a fluoropolymer containing hydroxy groups, this fluoropolymer in the coating material has a hydroxyl value of preferably 1-200 mg-KOH/g, more preferably 1-150 mg-KOH/g, still more preferably 3-100 mg-KOH/g, particularly preferably 10-60 mg-KOH/g, from the standpoint of the strength of the film.

The fluoropolymer in the coating material may have either an acid value or a hydroxyl value, or may have both.

The content of the fluoropolymer in the coating material is preferably 5-90 mass %, particularly preferably 10-80 mass %, based on the total mass of the solid components of the coating material, from the standpoint of the weatherability of the coated object.

The content of the fluoropolymer among the solid components of the coating material is preferably 10-90 mass %, particularly preferably 40-70 mass %, based on the mass of all the solid components of the coating material.

The coating material may contain a hardener for forming a crosslinked structure in the film described above.

In the case where the fluoropolymer in the coating material contains crosslinking groups, the coating film can be cured by reacting crosslinking groups of the fluoropolymer in the coating material with the hardener and thereby crosslinking the fluoropolymer. In this case, a coating film having a crosslinked structure configured from the fluoropolymer and the hardener is formed.

In the case where the hardener in the coating material has one or more groups selected from among a hydrolyzable silyl group and a silanol group, then a film having a crosslinked structure configured from the hardener, the glass plate containing silicon oxide, and optionally the fluoropolymer is formed by reacting the hardener with the glass plate and optionally with the fluoropolymer.

In the case where the coting material contains the hardener, the content of the hardener is preferably 5-200 parts by mass, particularly preferably 10-150 parts by mass, based on 100 parts by mass of the fluoropolymer in the coating material.

In the case where the coating material contains an inorganic pigment as inorganic particles, the coating material preferably contains a dispersant. In the case where the coating material contains the dispersant, the pigment is less apt to aggregate and expected optical properties are easy to obtain. Examples of the dispersant include those mentioned hereinabove.

The coating material preferably contains a liquid medium. Examples of the liquid medium include water and an organic solvent, and the organic solvent is preferred. In the case where the coating material contains the organic solvent, this coating material is preferably a solvent coating material which includes a fluoropolymer and the organic solvent and in which the organic solvent contains the fluoropolymer dissolved therein. In this case, enhanced adhesion is apt to be obtained between a base (specifically, a glass plate) and the coating film or between a primer layer formed on the base and the coating film.

Examples of the organic solvent include petroleum mixed solvents (e.g., toluene, xylene, Solvesso 100, manufactured by Exxon Mobil Corp., and Solvesso 150, manufactured by Exxon Mobil Corp.), aromatic hydrocarbon solvents (e.g., mineral spirit), ester solvents (e.g., ethyl acetate and butyl acetate), ketone solvents (e.g., methyl ethyl ketone, methyl isobutyl ketone, and cyclohexanone), and alcohol solvents (e.g., ethanol, tert-butyl alcohol, and isopropyl alcohol). Two or more organic solvents may be used in combination.

The antiviral material of the present invention has high antiviral properties and can hence be useful as antiviral materials. Specifically, the antiviral material of the present invention is applicable to various products including goggles, face shields, protective garments, panels, coating materials, and coating fluids for touch panels, and can diminish contact viral infections.

The antiviral material of the present invention exhibits a satisfactory inactivating effect on viruses such as animal viruses, insect viruses, plant viruses, and bacterial viruses (bacteriophages or phages). Examples of the animal viruses include an influenza virus, a coronavirus, a norovirus, a rotavirus, a retrovirus, an avian influenza virus, a classical swine fever virus, an adenovirus, a RS virus, a herpes virus, a measles virus, a rubella virus, an AIDS virus (HIV), a baculovirus, an insect poxvirus, and a cypovirus.

### EXAMPLES

The present invention is explained in detail below by reference to Examples, but the present invention is not limited to the Examples. In the following explanations, common ingredients or components used were identical, and “parts” and “%” mean “parts by mass” and “mass %”, respectively, unless otherwise indicated. Examples 1, 3, and 4 are Inventive Examples, and Examples 2 and 5 are Comparative Examples.

### Test Example 1

### Example 1

A coating material was applied to a surface of a glass substrate to form a wet film and the liquid medium was then removed, thereby forming a coating film of an antiviral material.

For producing a particle dispersion, “DISPERBYK-190” (trade name), manufactured by BYK-Chemie GmbH, was used as a dispersant, and “SOLMIX AP-1” (trade name), manufactured by Nihon Alcohol Corp., was used as a solvent. As precursors of a metal oxide of Si, tetraethoxysilane (TEOS) and 3-glycidoxypropyltrimethoxysilane (GPTMS) were used in the coating material.

### 1. Production of Particle Dispersion

To 18.57 g of AP-1 solvent were added 5.71 g of CuAlO₂ antiviral-material particles (average particle diameter, 50 nm) produced by the sol-gel method described hereinabove and 4.29 g of DISPERBYK-190. The resultant mixture was stirred. Thereto were added 100 g of zirconia beads having a diameter of 0.3 mm. This mixture was stirred with a paint shaker for about 6 hours and the zirconia beads were then removed by filtration to obtain a particle dispersion.

### 2. Production of Main-Ingredient Liquid

To 27.19 g of AP-1 solvent were added 17.23 g of TEOS, 6.15 g of GPTMS, and 0.33 g of “BYK-307” (trade name), manufactured by BYK-Chemie GmbH, as a surface regulator, followed by 7.20 g of acetic acid and 21.90 g of water. This mixture was sufficiently stirred. The resultant mixture was heated to 50° C. and held for 2 hours to thereby allow a reaction to proceed, and was then cooled to ordinary temperature to obtain a main-ingredient liquid. The main-ingredient liquid had a pH of 2.8.

### 3. Production of Coating Material

To 1.875 g of AP-1 solvent were added 3.125 g of the particle dispersion (solid content, 20 mass %) and 5 g of the main-ingredient liquid (solid content, 12.5 mass %) to obtain a coating material.

### 4. Application

The coating material was applied to a glass substrate (thickness, 2 mm), which was a float-process glass plate manufactured by AGC Inc., with a spin coater in such an amount as to result in a film thickness of 1.7 μm in terms of dry thickness. Thereafter, the coated glass substrate was heated for 30 minutes in a drying oven set at 200° C. Thus, a glass including the glass substrate and an antiviral coating film superposed thereon was obtained.

### Example 2

A glass substrate (thickness, 2 mm), which was the float-process glass plate manufactured by AGC Inc. and was in an unprocessed state with no antiviral coating film, was prepared in order to compare it with the case where an antiviral coating film was included and in order to calculate the antiviral activity value which will be described later.

### (Evaluation of Antiviral Properties)

The glass of Example 1 and the glass substrate of Example 2 were subjected to an antiviral property evaluation test.

In the antiviral property evaluation test, bacteriophage φ6 was used as a virus. This is one of viruses which infect P. syringae, and is a phage not included in the viruses to which JIS standards for photocatalysts apply. Although not infecting the human body, bacteriophage φ6 has a structure including an envelope and is hence used as a substitute for influenza viruses.

Evaluation was made under the following conditions with reference to ISO 21702 (2019) as evaluation test standards.

The specimens (the glass of Example 1 or the glass substrate of Example 2) used in the evaluation test had a size of 50 mm×50 mm. As a test phage was used bacteriophage φ6 (host, Pseudomonas syringae (NBRC 14084)). As a sterilization treatment before the test, cleaning by wiping with anhydrous ethanol was conducted. The evaluation was made in a dark environment under the action conditions of an action temperature of 25° C. and action periods of 1 hour, 6 hours, and 24 hours.

The test was conducted in the following manner.

1) The surface of each specimen was cleaned by wiping with anhydrous ethanol.

2) Onto the specimen, 0.4 mL of a virus-containing liquid (bacteriophage φ6 concentration, 1×10⁷ PFU/mL) was dropped. The specimen was then covered with a 40 mm×40 mm polypropylene film (“VF-10” (trade name), manufactured by KOKUYO Co., Ltd.). Thus, a test sample was obtained.

3) Such test samples were allowed to stand still at 25° C. for given time periods (1 hour, 6 hours, and 24 hours).

4) After the standing, the virus on each test sample was removed therefrom by washing with 10 mL of SCDLP culture medium and the specimen was recovered. Thereafter, the plaques which had formed were counted to thereby determine a virus infectivity titer.

5) From the virus infectivity titers obtained, an antiviral activity value was calculated using the following expression (1).

Antiviral activity value V=Ut−At (1)
Ut: common logarithm of virus infectivity titer (PFU/cm²) of unprocessed glass substrate (Example 2) after standing for a given period.
At: common logarithm of virus infectivity titer (PFU/cm²) of antiviral product (Example 1) after standing for the given period.

In Table 1 are shown the results of the antiviral property evaluation of Examples 1 and 2. Antiviral properties were assessed in the following manner. When a specimen had had an antiviral activity value of 2.5 or more after an action period of 24 hours, this specimen was deemed to show highly excellent antiviral properties and rated as “A”. When a specimen had had an antiviral activity value of 1.5 or more but less than 2.5, this specimen was deemed to show excellent antiviral properties and rated as “B”. When a specimen had had an antiviral activity value less than 1.5, this specimen was deemed to have low antiviral properties and rated as “C”.

With respect to Example 2, the antiviral activity values were unable to be calculated. However, since the infectivity titers were about 100 times as high as those in Example 1, the specimen of Example 2 was deemed to have low antiviral properties and rated as “C”.

TABLE 1

| | Infectivity titer (pfu/cm²) | | | V: antiviral activity value | | | Antiviral |
|---|---|---|---|---|---|---|---|
| | 1 hr | 6 hr | 24 hr | 1 hr | 6 hr | 24 hr | properties |
| Example 1 | 2.3 × 10⁴ | 4.8 × 10⁴ | 4.4 | −0.1 | −0.5 | 1.8 | B |
| Example 2 | 1.6 × 10⁴ | 1.3 × 10⁴ | 2.9 × 10² | — | — | — | C |

### (Composition, Thickness, and Appearance of Antiviral Coating Film)

With respect to the glass of Example 1, the weight proportions of materials in the antiviral coating film and the thickness and appearance of the antiviral coating film are shown in Table 2.

With respect to the weight proportions of materials in the antiviral coating film, the weight proportions of CuAlO₂ and metal oxide of Si were determined from the prepared coating material.

The thickness of the antiviral coating film was determined through an SEM examination of a section using “SU8030” (trade name), manufactured by Hitachi High-Technologies Corp.

The appearance of the antiviral coating film was visually examined and evaluated for color.

TABLE 2

| | | |
|---|---|---|
| Example 1 | Weight proportion of antiviral-material | 50 |
| | particles CuAlO₂ (wt %) | |
| | Weight proportion of metal oxide of | 50 |
| | Si (wt %) | |
| | Coating film thickness (μm) | 1.7 |
| | Appearance of coating film | Approximately colorless |
| | | and transparent |

### (Transmittance)

The glass of Example 1 and the glass substrate of Example 2 were examined for transmittance. The evaluated transmittance was spectral transmittance for the wavelength range of 300-800 nm, measured with spectrophotometer “U-4100” (trade name), manufactured by Hitachi High-Technologies Corp.

The results thereof are shown in FIG. 2.

It can be seen from Table 1 that the glass with an antiviral coating film of Example 1 had an antiviral activity value of 1.8 in an action period of 24 hours to exhibit a high antiviral effect due to CuAlO₂.

It was ascertained from Table 2 and FIG. 2 that the glass with an antiviral coating film of Example 1 had transparency.

### Test Example 2

### Example 3

### (Synthesis of CuAlO₂ Antiviral Bulk Material by Solid-Phase Reaction Method)

A Cu₂O powder and an Al₂O₃ powder (both manufactured by Kojundo Chemical Laboratory Co., Ltd.) were weighed out in amounts of 350.2 g and 249.8 g, respectively, and mixed together using a ball mill. The powder mixture was formed into a cylindrical shape having a diameter of 50.8 mm and a thickness of 5 mm using a uniaxial pressing machine. The resultant compact was put on a plate made of zirconium oxide stabilized with yttrium oxide, and this plate was introduced into an electric oven, where the compact was burned at 1,200° C. for 6 hours in an argon gas (Ar) atmosphere for lowering partial oxygen pressure. Argon gas was introduced at a flow rate of 200 sccm.

### Example 4

### (Synthesis of CuGaO₂ Antiviral Bulk Material by Solid-Phase Reaction Method)

A Cu₂O powder and a Ga₂O₃ powder (both manufactured by Kojundo Chemical Laboratory Co., Ltd.) were weighed out in amounts of 359.5 g and 340.1 g, respectively, and mixed together using a ball mill. The powder mixture was formed into a cylindrical shape having a diameter of 50.8 mm and a thickness of 5 mm using a uniaxial pressing machine. The resultant compact was put on a plate made of zirconium oxide stabilized with yttrium oxide, and this plate was introduced into an electric oven, where the compact was burned at 1,200° C. for 6 hours in an argon gas (Ar) atmosphere for lowering partial oxygen pressure. Argon gas was introduced at a flow rate of 200 sccm.

### Example 5

A glass substrate (thickness, 2 mm) in an unprocessed state with no antiviral coating film was prepared in order to compare it with the case where an antiviral coating film was included and in order to calculate the antiviral activity value.

### (Evaluation of Antiviral Properties)

The antiviral bulk materials of Examples 3 and 4 and the glass substrate of Example 5 were subjected to an antiviral property evaluation test. The evaluation was made in the same manner as in Test Example 1. Specimens of Examples 3 and 4 had the same size as the as-produced state (diameter, 50.8 mm; thickness, 5 mm), and specimens of Example 5 had a size of 50 mm×50 mm and a thickness of 2 mm.

In Test Example 2, in expression (1) for calculating the antiviral activity value V, the unprocessed glass substrate was Example 5 and the antiviral product was Example 3 or 4.

In Table 3 are shown the results of the antiviral property evaluation of Examples 3 to 5.

TABLE 3

| | Infectivity titer (pfu/cm²) | | | V: antiviral activity value | | | Antiviral |
|---|---|---|---|---|---|---|---|
| | 1 hr | 6 hr | 24 hr | 1 hr | 6 hr | 24 hr | properties |
| Example 3 | <25 | <10 | <10 | 4.6 | 5.0 | 4.7 | A |
| Example 4 | 870 | <10 | <10 | 3.1 | 5.0 | 4.7 | A |
| Example 5 | 1.1 × 10⁶ | 1.0 × 10⁶ | 4.7 × 10⁵ | — | — | — | C |

The results given in Table 3 show that Examples 3 and 4 had antiviral activity values of 2.5 or more in an action period of 1 hour to exhibit a highly excellent antiviral effect.

With respect to Example 5, the antiviral activity values were unable to be calculated. However, since the infectivity titers were far higher than those in Examples 3 and 4, Example 5 was deemed to have low antiviral properties (rated as C).

While the invention has been described in detail and with reference to specific embodiments thereof, it will be apparent to one skilled in the art that various changes and modifications can be made therein without departing from the spirit and scope thereof. This application is based on a Japanese patent application filed on Jul. 22, 2020 (Application No. 2020-125649), the contents thereof being incorporated herein by reference.

1. An antiviral material comprising a Cu-M-O compound,
wherein the Cu at least includes a monovalent-state Cu and the M is at least one element selected from the group consisting of B, Al, Sc, Ti, Co, Cr, Ni, Ga, Y, Zr, In, Rh, and a lanthanoid.

2. The antiviral material according to claim 1, wherein the Cu-M-O compound comprises delafossite crystals represented by CuMO₂.

3. A laminate comprising:
a base; and
a thin film disposed on the base and including the antiviral material according to claim 1.

4. Particles comprising the antiviral material according to claim 1.

5. A coating material comprising the particles according to claim 4.

6. A coated object comprising:
a base; and
a coating film disposed on the base and formed from the coating material according to claim 5.

7. A fiber comprising the antiviral material according to claim 1.

8. An antiviral material comprising a Cu-M-M′-O compound,
wherein the Cu at least includes a monovalent-state Cu, the M is at least one element selected from the group consisting of B, Al, Sc, Ti, Co, Cr, Ni, Ga, Y, Zr, In, Rh, and a lanthanoid, and the M′ is Ag or Pd.

9. The antiviral material according to claim 8, wherein the Cu-M-M′-O compound comprises delafossite crystals represented by (Cu-M′)MO₂.

10. A laminate comprising:
a base; and
a thin film disposed on the base and including the antiviral material according to claim 8.

11. Particles comprising the antiviral material according to claim 8.

12. A coating material comprising the particles according to claim 11.

13. A coated object comprising:
a base; and
a coating film disposed on the base and formed from the coating material according to claim 12.

14. A fiber comprising the antiviral material according to claim 8.
